(19) United States
(12) Patent Application Publication
(10) Pub. No.: US 2008/0068518 A1
(43) Pub. Date: Mar. 20, 2008

(54) PROJECTION TELEVISION AND MOLD FOR MOLDING CABINET OF THE SAME

(75) Inventors: Kyoung Youn LEE, Suwon-si (KR); Woo Young KAN, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/838,366

(22) Filed: Aug. 14, 2007

(30) Foreign Application Priority Data
Sep. 14, 2006 (KR) 2006-89355

(51) Int. Cl. H04N 5/64; A47B 81/06

(52) U.S. Cl. 348/836; 312/7.2; 348/787

(57) ABSTRACT

A projection television (TV) and a mold for molding a cabinet of the same are capable of reducing the number of parts and simplifying a production process. The projection TV includes a cabinet that has an upper space holding a mirror and a lower space holding an optical unit, wherein the cabinet has a rear part supporting the mirror, a partition partitioning an inner space thereof into the upper space and the lower space, a front part closing a front of the lower space, and a base located at a bottom of the lower space, all of which are integrally molded.

### CROSS-REFERENCE TO RELATED APPLICATION

This application claims priority from Korean Patent Application No. 10-2006-0089355, filed on Sep. 14, 2006, in the Korean Intellectual Property Office. The priority application is incorporated herein by reference in its entirety.

### BACKGROUND OF THE INVENTION

1. Field of the Invention

The present invention relates generally to a projection television (TV) and, more particularly to a projection TV having an integral cabinet, and a mold for molding the cabinet of the projection TV.

2. Description of the Related Art

A projection television (“TV”) is an apparatus for projecting an image using an optical unit on the rear of a screen to form a picture. An example of a projection TV is disclosed in Korean Patent Publication No. 2004-84991.

The projection TV disclosed in the above document includes an upper cabinet in which a mirror is installed, and a lower cabinet that is coupled to a lower portion of the upper cabinet and holds an optical unit. A screen is installed on the front of the upper cabinet, and an inner space of the upper cabinet and an inner space of the lower cabinet are partitioned from each other.

To produce this projection TV, the upper and lower cabinets are separately molded, and then are coupled to each other by means of fixing screws. In the case where assembly deviation occurs in the process of mutually coupling the upper and lower cabinets, an image projected on the screen may be distorted. In addition, during the use of the projection TV, heat from the optical unit causes a joint between the upper and lower cabinets to expand and contract, which may generate noise.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

In one aspect, the present invention relates to a projection television (TV), which includes a cabinet that has an upper space holding a mirror and a lower space holding an optical unit. The cabinet has a rear part supporting the mirror, a partition partitioning an inner space thereof into the upper space and the lower space, a front part closing a front of the lower space, and a base located at a bottom of the lower space, all of which are integrally molded.

The cabinet may further include side parts that close opposite sides of the upper space and are integrally molded with the rear part and the partition.

Further, the partition may be provided with at least one opening for securing an optical path.

Further, the rear part may be connected with a rear end of the partition, and the front part may be connected with a front end of the partition at an upper end thereof, and a front end of the base at a lower end thereof.

Also, the base may be provided with at least one rail that guides mounting of the optical unit.

In addition, the projection TV may further include a screen installed to a front of the upper space, a front panel coupled to a front of the cabinet and having an opening for exposing the screen, and a rear panel coupled to the cabinet so as to close a rear of the lower space.

In another aspect, the present invention relates to a projection TV, which includes an integral cabinet having upper and lower spaces partitioned from each other, a mirror installed in the upper space of the cabinet, a screen installed to a front of the upper space, an optical unit and at least one of electric and electronic parts installed in the lower space, a rear panel detachably coupled to a rear of the lower space, and a supporting bracket mounted in the lower space in a state where the optical unit and the at least one of electric and electronic parts are mounted thereon so as to facilitate mounting of the optical unit and the electric or electronic parts.

The supporting bracket may be slid and mounted in the lower space.

Further, the cabinet may include at least one guide rail, which guides the mounting of the supporting bracket, in the lower space.

In another aspect, the present invention relates to a mold for molding a cabinet of a projection TV, in which the projection TV includes the cabinet having upper and lower spaces, a rear part at a rear of the upper space, a partition partitioning an inner space of the cabinet into the upper space and the lower space, a front part closing a front of the lower space, and a base at a bottom of the lower space. The mold includes first and second molds that are joined and separated in opposite directions. The first and second molds define a mold cavity configured to form the partition, the front part, and an upper surface of the base. A third mold is joined with the first and second molds in a direction perpendicular to the directions in which the first and second molds are joined. The third mold defines another mold cavity configured to form a lower surface of the base.

The first mold may include a first molding part for forming an inner surface of the upper space, and a second molding part for forming a front of the front part. The second mold may include a third molding part for forming an outer surface of the rear part, and a fourth molding part for forming an inner surface of the lower space. The third mold may include a fifth molding part for forming the lower surface of the base.

Further, the third mold may include a plurality of ejector pins configured to separate the base from the third mold.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view illustrating a projection television (TV) in accordance with an embodiment of the present invention;

FIG. 2 is a sectional view illustrating a projection TV in accordance with an embodiment of the present invention;

FIG. 3 is a sectional view illustrating the cabinet of a projection TV in accordance with an embodiment of the present invention;

FIG. 4 is a sectional view illustrating a mold for molding the cabinet of a projection TV in accordance with an embodiment of the present invention;

FIG. 5 is a sectional view illustrating a mold for molding the cabinet of a projection TV in accordance with an embodiment of the present invention;

FIG. 6 is a perspective view illustrating a mounting structure of the optical unit of a projection TV in accordance with an embodiment of the present invention.

### DETAILED DESCRIPTION OF EXEMPLARY EMBODIMENTS OF THE INVENTION

Hereinafter, an exemplary embodiment of the present invention will be described in detail with reference to the accompanying drawings.

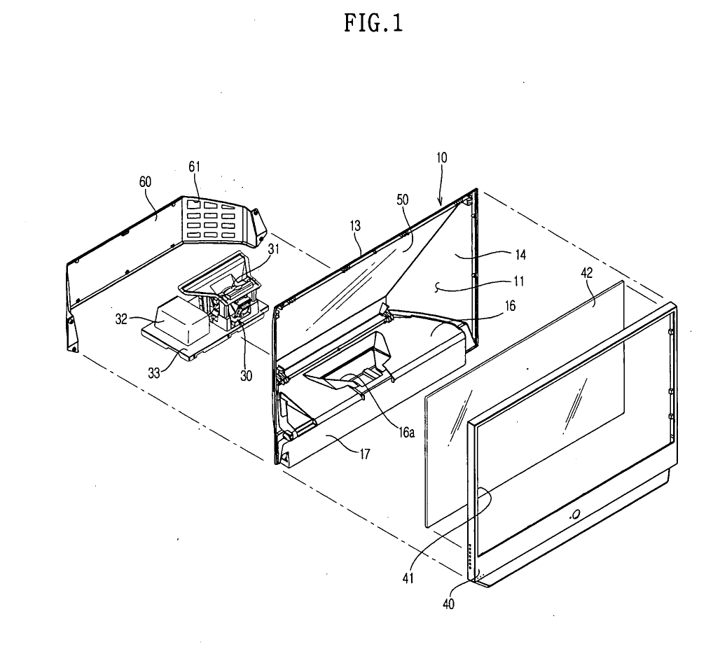

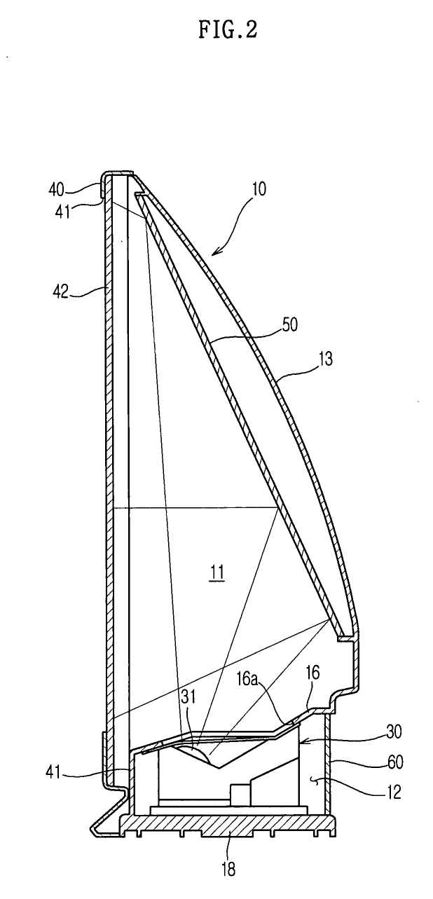

As illustrated in FIGS. 1 and 2, a projection television (“TV”) in accordance with an embodiment of the present invention includes an optical unit 30 installed an inner lower portion of a cabinet 10, a screen 42 installed to the front of the cabinet 10, and a mirror 50 sending an image, projected from the optical unit 30, to the screen 42. Further, the projection TV includes a front panel 40 coupled to the front of the cabinet 10 and a rear panel 60 coupled to the rear of the cabinet 10.

The cabinet 10 has an inner space, which is divided into an upper space 11 in which the mirror 50 is installed and a lower space 12 in which the optical unit 30 is installed. The cabinet 10 includes a rear part 13, which is configured to close the rear of the upper space 11 and provides an inner surface to which the mirror 50 is fixed. The cabinet further includes two side parts 14 and 15 disposed on opposite sides of the rear part 13, a partition 16 configured to partition the inner space of the cabinet 10 into the upper and lower spaces 11 and 12, a front part 17 configured to close the front of the lower space 12, and a base 18 disposed at a bottom of the lower space 12. The cabinet 10 may be integrally molded by injection molding of a resin material.

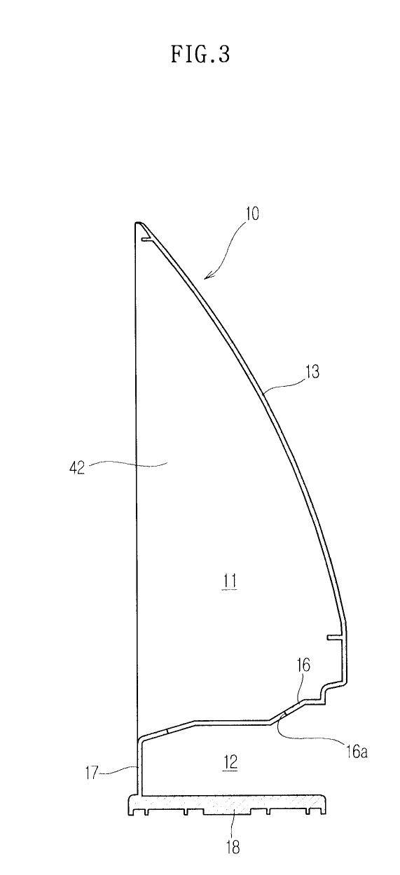

As illustrated in FIG. 3, the cabinet 10 is integrally molded such that: a lower end of the rear part 13 is connected to a rear end of the partition 16; an upper end of the front part 17 is connected to a front end of the partition 16; a lower end of the front part 17 is connected to a front end of the base 18; and the side parts 14 and 15 are connected with the rear part 13 and the partition 16. The front of the upper space 11 and the rear of the lower space 12 are open. This construction simplifies the structure of a mold for molding the cabinet 10 and allows for the complicated shape of cabinet 10 to be easily molded.

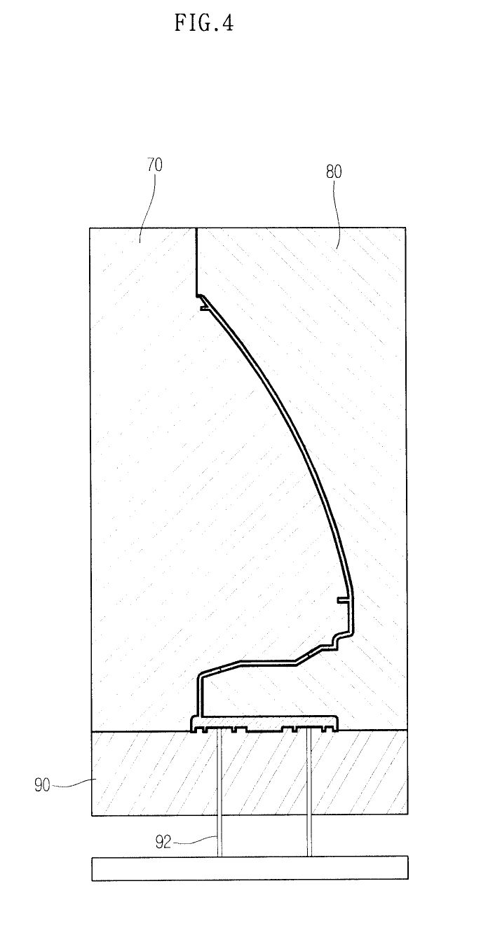

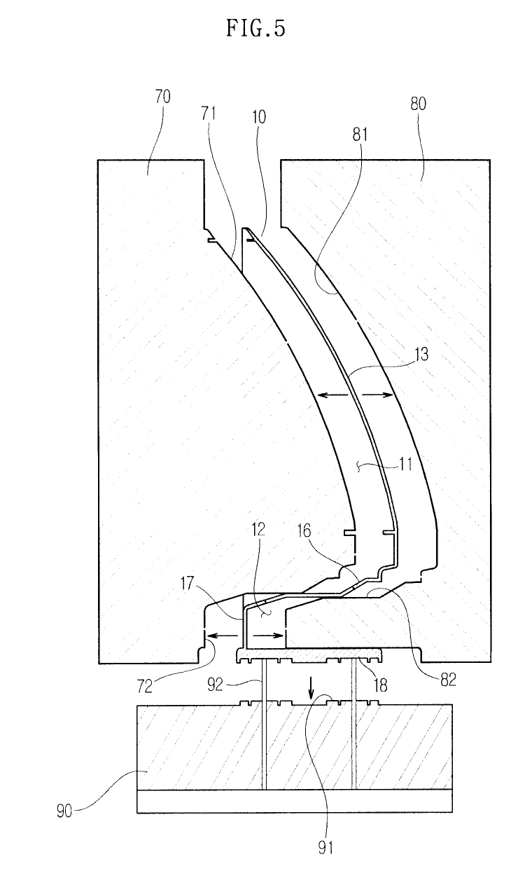

FIGS. 4 and 5 are sectional views illustrating a mold for molding a cabinet. The mold includes first mold 70 and second mold 80, which are joined and separated in opposite directions. A third mold 90 is joined with and separated from the first mold 70 and second mold 80 in a direction perpendicular to the directions in which the first mold 70 and second mold 80 are joined and separated.

As illustrated in FIG. 5, the first mold 70 includes a first molding part 71 for forming an inner surface of the upper space 11 of the cabinet 10 and a second molding part 72 for forming the front of the front part 17 of the cabinet 10. The second mold 80 includes a third molding part 81 for forming outer surfaces of the rear part 13 and opposite side parts 14 and 15 of the cabinet 10 and a fourth molding part 82 for forming an inner surface of the lower space 12 of the cabinet 10. The third mold 90 includes a fifth molding part 91 for forming a lower surface of the base 18 of the cabinet 10. Further, the third mold 90 includes a plurality of ejector pins 92 for separating a cabinet form from the third mold 90 while separated from the other molds.

As illustrated in FIG. 4, when the first, second and third molds 70, 80 and 90 are joined with one another, the first to fifth molding parts 71, 72, 81, 82 and 91 define a mold cavity for molding the cabinet 10. In this manner, the mold for molding the cabinet 10 in accordance with an exemplary embodiment of the present invention can simplify its structure and operating principle and integrally mold the complicated shape of the cabinet 10 through a single molding process.

As illustrated in FIG. 2, the partition 16 of the cabinet 10 partitions the inner space of the cabinet 10 into the upper space 11 in which the mirror 50 is installed and a lower space 12 in which the optical unit 30 is installed, thereby preventing foreign materials such as dust from being introduced into the upper space 11. The partition 16 includes an opening 16a, which allows for an image to be projected toward the mirror 50 from the optical unit 30.

Although not illustrated in detail in the figures, the optical unit 30 includes a light source emitting light, a display device receiving the light from the light source and realizing an image, and a projection lens module 31 projecting the image realized by the display device toward the mirror at the rear of the upper space 11 of the cabinet 10. Those having ordinary skill in the art will appreciate that the present invention is not limited to any particular type of optical unit.

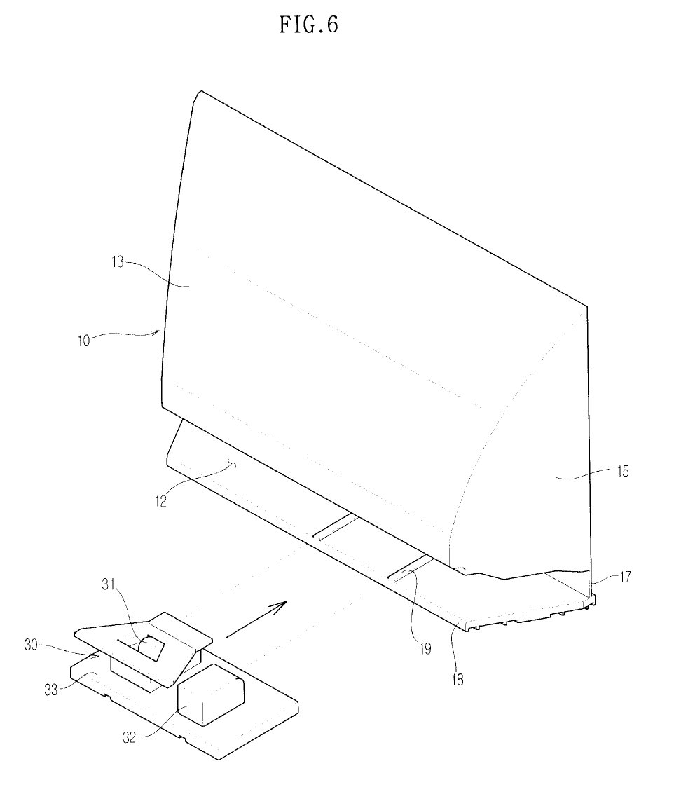

As illustrated in FIG. 6, the optical unit 30 is mounted on a plate-like supporting bracket 33 together with electric or electronic parts 32, and then is slid and mounted in the lower space 12. In other words, the optical unit 30 and the electric or electronic parts 32 are assembled on the supporting bracket 33, and then are installed together in the lower space 12 of the cabinet 10. To this end, the base 18 of the cabinet 10 may be provided, on an inner surface thereof, with guide rails 19 that guide the supporting bracket 33 to be mounted in the lower space 12. With this construction, the optical unit 30 and the electric or electronic parts 32 can be easily installed only by mounting the supporting bracket 33 in the lower space 12, which allows for the projection lens module 31 of the optical unit 30 to be installed at a precise position. Further, the optical unit 30 and the electric or electronic parts 32 can be easily disassembled for future repair if the projection TV gets out of order.

Although not illustrated in detail in the figures, the electric or electronic parts 32 mounted on the supporting bracket 33 can include a control unit such as a circuit board for controlling driving of the optical unit 30, a power supply unit controlling voltage or electric power, various signaling modules, and a cooling means, such as a heat sink or a cooling fan. In addition, any part installed in the lower space 12 of the cabinet 10 can be mounted on the supporting bracket 33.

As illustrated in FIG. 1, the front panel 40 installed to the front of the cabinet 10 has an opening 41 for exposing the screen 42. The front panel 40 can be fixed at the front of the cabinet 10 by means of at least one fixing screw (not shown) with the screen 42 mounted therein. The front panel 40 covers the front part 17 of the cabinet 10 located at the front of the lower space 12, thereby improving the aesthetics of the cabinet.

As illustrated in FIGS. 1 and 2, the rear panel 60 may be detachably coupled to the rear of the lower space 12 by means of at least one fixing screw (not shown). The rear panel 60 is provided with a plurality of vent holes 61 such that air for cooling the optical unit 30 can be circulated.

In order to assemble this exemplary embodiment of a projection TV, the mirror 50 is mounted in the upper space 11 of the cabinet 10. Then, the supporting bracket 33, on which the optical unit 30 and the electric or electronic parts 32 are mounted, is slid and mounted in the lower space 12 of the cabinet 10. At this time, the cabinet 10 in accordance with an embodiment of the present invention can minimize error in the assembly of the optical unit 30 because the rear part 13 to which the mirror 50 is mounted is integrally molded with the base 18 to which the optical unit 30 is mounted, and because the optical unit 30 is guided along the guide rails 19 of the base 18 when mounted. By reducing error in the assembly of the optical unit 30, distortion of the image projected on the screen 42 can be minimized.

The screen 42 is mounted onto the front panel 40. After the optical unit 30 is mounted, the front panel 40 is mounted to the front of the cabinet 10. Then, the rear panel 60 is mounted to the rear of the cabinet 10.

Embodiments of the present invention may include one or more of the following advantages. As described in detail above, a projection TV in accordance with an exemplary embodiment of the present invention may have the rear part, the partition, the front part, and the base of the cabinet integrally molded. By so doing, the number of parts can be reduced, an assembly process can be simplified, and the parts can be precisely assembled.

Further, due to the integral cabinet, the optical unit, the mirror, etc. can be precisely mounted in place. Therefore, distortion of the image projected on the screen can be minimized.

Furthermore, because the supporting bracket on which the optical unit and the electric or electronic parts are mounted is slid and mounted in the lower space of the cabinet, the assembly process of the parts can be simplified, and the future repair can be easily performed.

In addition, the rear part supporting the mirror, the partition partitioning the inner space of the cabinet into the upper space and the lower space, the front part closing the front of the lower space, and the base located at the bottom of the lower space are integrally molded, which simplifies the structure of the mold for molding the cabinet and allows for the complicated shape of the cabinet to be easily molded through a single molding process.

Although the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A projection television (TV) comprising:
a cabinet comprising,
a rear part,
a partition partitioning an inner space of the cabinet into an upper space and a lower space,
a front part closing a front of the lower space, and
a base located at a bottom of the lower space;
a mirror disposed in the upper space, wherein the rear part supports the mirror; and
an optical unit disposed in the lower space,
wherein the rear part, the partition, the front part, and the base of the cabinet are integrally molded.

2. The projection TV as recited in claim 1, wherein the cabinet further comprises side parts configured to close opposite sides of the upper space, wherein the side parts are integrally molded with the rear part and the partition.

3. The projection TV as recited in claim 1, wherein the partition comprises at least one opening configured to provide an optical path between the mirror and the optical unit.

4. The projection TV as recited in claim 1, wherein the rear part is connected to a rear end of the partition and the front part is connected to a front end of the partition at an upper end thereof and a front end of the base at a lower end thereof.

5. The projection TV as recited in claim 1, wherein the base comprises at least one rail configured to guide mounting of the optical unit.

6. The projection TV as recited in claim 3, further comprising:
a screen disposed on a front of the upper space;
a front panel coupled to a front of the cabinet and having an opening for exposing the screen; and
a rear panel coupled to the cabinet and configured to close a rear of the lower space.

7. A projection television (TV) comprising:
an integral cabinet having upper and lower spaces partitioned from each other;
a mirror disposed in the upper space of the cabinet;
a screen disposed on a front of the upper space;
an optical unit and at least one of electric and electronic parts disposed in the lower space;
a rear panel detachably coupled to a rear of the lower space; and
a supporting bracket mounted in the lower space, wherein the optical unit and the at least one of electric and electronic parts are mounted thereon.

8. The projection TV as recited in claim 7, wherein the supporting bracket is slid and mounted in the lower space.

9. The projection TV as recited in claim 7, wherein the cabinet comprises at least one guide rail configured to guide the mounting of the supporting bracket in the lower space.

10. A mold for molding a cabinet of a projection television (TV), in which the projection TV comprises the cabinet having upper and lower spaces, a rear part at a rear of the upper space, a partition partitioning an inner space of the cabinet into the upper space and the lower space, a front part closing a front of the lower space, and a base at a bottom of the lower space, the mold comprising:
first and second molds that are joined and separated in opposite directions, wherein the first and second molds define a mold cavity configured to form the partition, the front part, and an upper surface of the base; and
a third mold that is joined with the first and second molds in a direction perpendicular to the directions in which the first and second molds are joined, wherein the third mold defines another mold cavity configured to form a lower surface of the base.

11. The mold for molding a cabinet of a projection TV as recited in claim 10, wherein:
the first mold comprises a first molding part configured to form an inner surface of the upper space and a second molding part configured to form a front of the front part;
the second mold comprises a third molding part configured to form an outer surface of the rear part and a fourth molding part configured to form an inner surface of the lower space; and
the third mold comprises a fifth molding part configured to form the lower surface of the base.

12. The mold for molding a cabinet of a projection TV as recited in claim 11, wherein the third mold comprises a plurality of ejector pins configured to separate the base from the third mold.
